(19) United States
(12) Patent Application Publication
(10) Pub. No.: US 2025/0353093 A1
(43) Pub. Date: Nov. 20, 2025

(54) METHOD OF JOINING DISSIMILAR MATERIAL PIPES AND JOINED DISSIMILAR MATERIAL PIPE

(71) Applicants: HYUNDAI MOTOR COMPANY, SEOUL (KR); KIA CORPORATION, SEOUL (KR)

(72) Inventors: In-Beom Lee, Hwaseong-si (KR); Jae-Hong Park, Hwaseong-si (KR); Hyun-Min Sung, Hwaseong-si (KR)

(73) Assignees: HYUNDAI MOTOR COMPANY, SEOUL (KR); KIA CORPORATION, SEOUL (KR)

(21) Appl. No.: 18/822,895

(22) Filed: Sep. 3, 2024

(30) Foreign Application Priority Data
May 17, 2024 (KR) 10-2024-0064397

(51) Int. Cl. B23K 1/19; B23K 1/00; B23K 3/08; B23K 101/10; B23K 103/04; B23K 103/10; F16L 13/02

(52) U.S. Cl. CPC B23K 1/19; B23K 1/0012; B23K 3/087; F16L 13/02; B23K 2101/10; B23K 2103/04; B23K 2103/10

(57) ABSTRACT

A method of joining dissimilar material pipes includes applying a brazing metal filler to an end of a first pipe, press-inserting the end of the first pipe, with the brazing metal filler applied, into a second pipe, and plastically deforming and joining overlapping plastic deformation portions of the first pipe and the second pipe in a joint assembly, where the first pipe is fitted to the second pipe. This method offers joined dissimilar material pipe, which provides improved sealing capacity and perform well under high pressure and extremely low temperatures.

### CROSS REFERENCE TO RELATED APPLICATIONS

This application claims priority to Korean Patent Application No. 10-2024-0064397, filed on May 17, 2024, which is incorporated herein by reference in its entirety.

### BACKGROUND

### Field of the Disclosure

Exemplary embodiments of the present disclosure relate to a method of joining dissimilar material pipes and the resulting joined dissimilar material pipe.

### Description of Related Art

In piping for transporting fluids, a need often arises to join dissimilar material pipes. Liquid hydrogen storage tanks, for instance, require such pipe joining.

Liquid hydrogen systems have a higher volumetric energy density than conventional gaseous hydrogen systems, which drives the increased need for liquid hydrogen system applications. When supplying to fuel cell systems, liquid hydrogen is converted into gaseous hydrogen through a heat exchanger before being supplied.

A critical aspect of this system is joining pipes at pipe joints between a stainless steel (SUS) hydrogen storage tank and an aluminum (Al) heat exchanger. Conventionally, rotary friction welding (RFW) is used for joining these dissimilar material pipes.

However, the RFW is a joining process that works by applying rotation and pressure, requiring a certain minimum thickness for each pipe. This requirement may inevitably increase the weight and size of the pipes.

Furthermore, the RFW may cause quality defects due to cracks at pipe joints and contact between dissimilar material materials may raise concerns about galvanic corrosion.

Conventional methods of insert-fitting two pipes using dissimilar material pipe- to-pipe fittings are difficult to apply to rigid materials such as steel and leave fitting members in place even after the pipes are inserted.

In addition, there are methods of joining two components by welding and forming using electromagnetic pulses, but such welded joints have a high risk of quality defects and difficulty in securing sealing capacity.

The information disclosed in this Background section is only for enhancement of understanding of the general background of the disclosure and therefore it may contain information that does not form the prior art that is already known to a person of ordinary skill in the art.

The related art of the present disclosure is disclosed in Korean Patent Application Publication No. 10-2019-0102450 and Korean Patent No. 10-1924574.

### SUMMARY

Various aspects are directed to a method of joining dissimilar material pipes and the resulting joined dissimilar material pipe, which provide excellent sealing capacity and perform well under high pressure and extremely low temperatures.

In an aspect of the present disclosure, a method of joining dissimilar material pipes includes applying a brazing metal filler to an end of a first pipe by an applicator 50, press-inserting the end of the first pipe by a press-inserting apparatus, with the brazing metal filler applied, into a second pipe, and plastically deforming and joining a plastic deformation portion where the first pipe and the second pipe overlap in a joint assembly, where the first pipe is inserted to the second pipe.

The first pipe and the second pipe are made of dissimilar material materials.

In addition, the first pipe and the second pipe are contactless.

The method further includes heat-treating the joined plastic deformation portion in the joint assembly and melting the brazing metal filler.

The applying of the brazing metal filler covers a longitudinal length corresponding to a range between ⅖ and ⅗ of the length of the plastic deformation portion.

The brazing metal filler has an alloy composition with a melting point of 450-550° C., and the melting of the brazing metal filler includes heat treatment of the plastic deformation portion at a temperature of 450-550° C.

Furthermore, the joining may include placing the joint assembly between multiple jigs in a rotary swaging device and operating the rotary swaging device to allow the jig to apply radial pressure to the joint assembly.

A pressing portion of the jig may have a tapered shape on a side, and a curvature of the curve between the bottom and the side of the jig may be 60 ϕ [mm] or less.

The first pipe may be an aluminum (Al) pipe on a heat exchanger side in a liquid hydrogen system and the second pipe may be a steel pipe on a hydrogen storage tank side in the liquid hydrogen system.

In another aspect of the present disclosure, dissimilar material pipes include a first pipe, a brazing metal filler applied to an end of the first pipe, and a second pipe into which the end of the first pipe, with the brazing metal filler applied, is press-inserted. A plastic deformation portion where the first pipe and the heat shrinkable tube overlap are plastically deformed and joined.

In this case, the brazing metal filler is melted to fill a gap between the first pipe and the second pipe for joining, and the first pipe and the second pipe are contactless.

Additionally, the first pipe and the second pipe are made of dissimilar material materials.

The brazing metal filler has an alloy composition with a melting point of 450-550° C.

The plastic deformation portion is plastically deformed by applying radial pressure.

The first pipe may be an Al pipe on a heat exchanger side in a liquid hydrogen system and the second pipe may be a steel pipe on a hydrogen storage tank side in the liquid hydrogen system.

Conventionally, there are restrictions on the thickness of pipes. However, the method of joining dissimilar material pipes reduces these restrictions by shape-based joining through plastic deformation.

In addition, conventional welding often raises concerns about quality defects and reduced durability. However, the method offers a weldingless joining process, which eliminates quality defects and durability issues caused by heat.

The application of brazing metal filler may prevent galvanic corrosion by avoiding contact between dissimilar material materials.

Thus, the method may create a pipe joint of dissimilar material materials (SUS-Al) that performs well under high pressure and extremely low temperatures, and ensure sealing capacity, the most critical characteristic, by allowing for the incorporation of sealing members.

Accordingly, the pipe joint may effectively connect a heat exchanger and a liquid hydrogen storage tank in a fuel cell electric vehicle (FCEV).

### BRIEF DESCRIPTION OF THE FIGURES

FIGS. 1, 2, 3, 4, 5, and 6 sequentially illustrate a method of joining dissimilar material pipes according to an embodiment of the present disclosure.

FIG. 7 illustrates a part of a jig for the method of joining dissimilar material pipes according to an embodiment of the present disclosure.

FIG. 8 illustrates dissimilar material pipes joined by the method of joining dissimilar material pipes according to an embodiment the present disclosure.

### DETAILED DESCRIPTION

In order to fully understand the present disclosure, operational advantages of the present disclosure, objectives achieved by embodiments of the present disclosure, reference should be made to the accompanying drawings and contents illustrated in the accompanying drawings which illustrate the preferred embodiments of the present disclosure.

In describing preferred embodiments of the present disclosure, known techniques or repetitive descriptions that may unnecessarily obscure the gist of the present disclosure will be reduced or omitted in such descriptions.

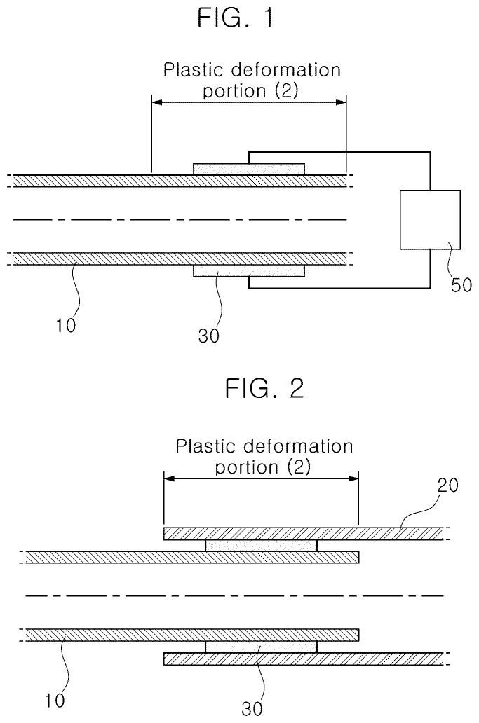

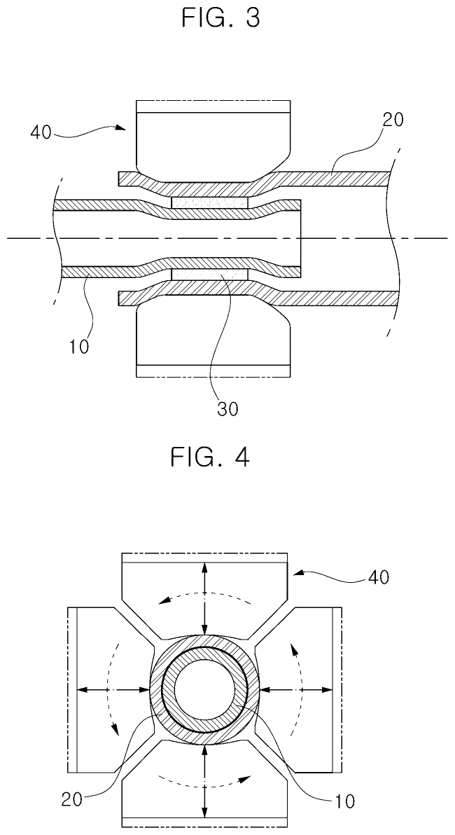

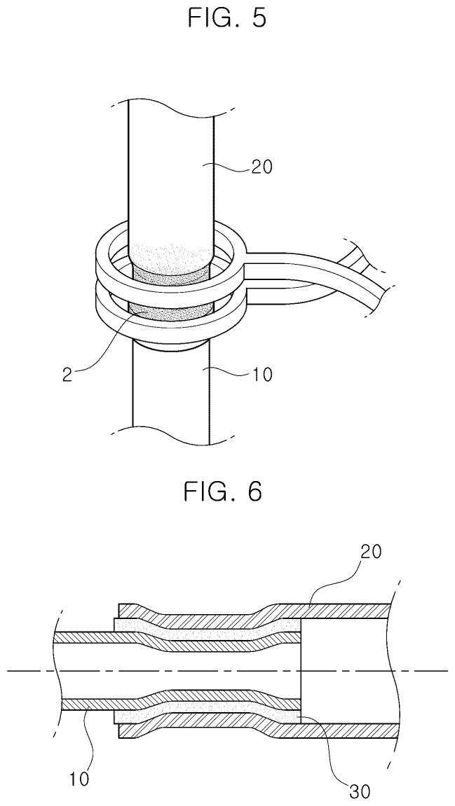

FIGS. 1 to 6 sequentially illustrate a method of joining dissimilar material pipes according to an embodiment of the present disclosure.

A method of joining dissimilar material pipes and the dissimilar material pipe according to an embodiment of the present disclosure will be described hereinafter with reference to FIGS. 1 to 6.

The embodiment relates to a method of joining two dissimilar material pipes into a single component, which may be applied to tubular products such as pipes or shafts.

For example, the single component may be a connection pipe that effectively connects a heat exchanger and a liquid hydrogen storage tank in a fuel cell electric vehicle (FCEV). In this case, a first pipe 10 may be an aluminum (Al) pipe on the heat exchanger side, and a second pipe 20 may be a steel pipe on the hydrogen storage tank side.

First, the first pipe 10 may be an extrusion made of 6000 series Al, and a brazing metal filler 30 is applied to the outer surface of the first pipe 10. The brazing metal filler 30 is preferably applied centered on a plastic deformation portion of the first pipe 10. The application may cover a longitudinal length corresponding to a range between ⅖ and ⅗ of the length of the plastic deformation portion.

The brazing metal filler 30 preferably has an alloy composition with a melting point of 450-550° C. Examples may include 20 wt % Al+Zn, 50 wt % Al+Si+Zn, or 86 wt % Al+Si+Cu, based on weight percent.

Then, the first pipe 10, with the brazing metal filler 30 applied, is press-inserted into the second pipe 20, which is dissimilar material to the first pipe 10. The press-inserted length corresponds to the length of the plastic deformation portion, and the second pipe 20 may be a stainless steel (SUS) pipe.

The method ensures joining such dissimilar material pipes through a rotary swaging process. Rotary swaging is a forging process that shapes a workpiece by applying radial rotating pressure toward the center of a shaft. This process is primarily used for thin-walled, multi-diameter shafts.

Therefore, the plastic deformation portion of the prepared components, as described above, is placed between multiple jigs 40 in a rotary swaging device.

When the rotary swaging device is operated, hammers, actuated by pressure rollers rotating from outside the jig 40, press against the jig 40. The jig 40 then applies radial pressure to the outer surface of a joint assembly, causing plastic deformation of the assembly for joining.

For example, a roller speed of 1200 rpm, a hammer speed of 500 rpm, and a jig speed of 200 rpm may be applied to exert rotation and pressure for plastically deforming the joint assembly.

Next, heat treatment (using a furnace, induction heating, torch, etc.) is carried out at a temperature (450-550° C., below the melting point of Al) suitable for the brazing metal filler 30. This allows the metal filler to melt and infiltrate the SUS and Al, thus joining the two materials. During this process, capillary action ensures that the remaining unfilled areas of a plastic deformation portion 2 are also joined.

As described above, the method offers both weldingless physical joining and chemical joining, which may eliminate quality defects and durability issues caused by heat.

In addition, galvanic corrosion may be prevented since the first pipe 10 and the second pipe 20 are contactless.

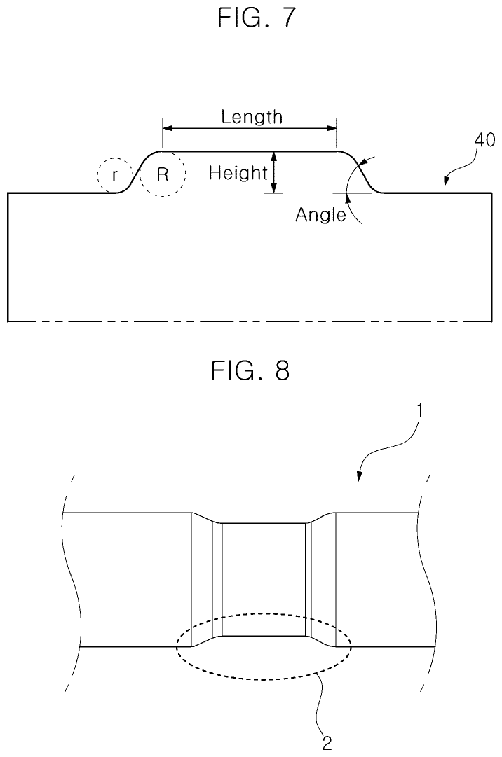

FIG. 7 shows a pressing portion of the jig in the rotary swaging device.

For example, the jig may be 100 mm or less in length and 5 mm or less in height.

For smooth pressing and a high-quality plastic deformation portion, a pressing portion preferably has a tapered shape on a side.

Therefore, an angle of the drawing is preferably 80° or less, and the bottom and the side are smoothly connected in a curved manner. Additionally, a curvature (R) is preferably 60 ϕ mm or less (curved surface of 60 mm or less).

Due to the shape of the pressing portion of the jig, the plastic deformation portion 2 of a dissimilar material pipe 1 is plastically deformed and joined as shown in FIG. 8.

While the present disclosure has been described with reference to the embodiments illustrated in the drawings, it will be obvious to those skilled in the art that the present disclosure is not limited to the disclosed embodiments, but may be variously modified and arranged without departing from the technical spirit and scope of the present disclosure. Thus, it is to be understood that the present disclosure is intended to cover various modifications and arrangements within the scope of the appended claims. Accordingly, the scope of the present disclosure should be defined by following claims.

1. A method of joining dissimilar material pipes comprising:
applying a brazing metal filler to an end of a first pipe;
press-inserting the end of the first pipe, with the brazing metal filler applied, into a second pipe; and
plastically deforming and joining a plastic deformation portion where the first pipe and the second pipe overlap in a joint assembly, wherein the first pipe is inserted to the second pipe.

2. The method of claim 1, wherein the first pipe and the second pipe are made of dissimilar materials.

3. The method of claim 1, wherein the first pipe and the second pipe are contactless.

4. The method of claim 1, further comprising heat-treating the plastic deformation portion in the joint assembly and melting the brazing metal filler.

5. The method of claim 4, wherein the applying of the brazing metal filler covers a longitudinal length corresponding to a range between ⅖ and ⅗ of a length of the plastic deformation portion.

6. The method of claim 4, wherein the brazing metal filler has an alloy composition with a melting point of 450-550° C. and the melting of the brazing metal filler includes heat treatment of the plastic deformation portion at a temperature of 450-550° C.

7. The method of claim 1, wherein the joining comprises:
placing the joint assembly between multiple jigs in a rotary swaging device; and
operating the rotary swaging device to allow the jig to apply radial pressure to the joint assembly.

8. The method of claim 7, wherein a pressing portion of each of the multiple jigs has a tapered shape on a side and a curvature of curve between a bottom and side of each of the multiple jigs is 60 ϕ mm or less.

9. The method of claim 1, wherein the first pipe is an aluminum (Al) pipe on a heat exchanger side in a liquid hydrogen system, and the second pipe is a steel pipe on a hydrogen storage tank side in the liquid hydrogen system.

10. A dissimilar material pipe comprising:
a first pipe;
a brazing metal filler applied to an end of the first pipe; and
a second pipe into which the end of the first pipe, with the brazing metal filler applied, is press-inserted;
wherein a plastic deformation portion of the first pipe and a heat shrinkable tube overlap are plastically deformed and joined.

11. The dissimilar material pipe of claim 10, wherein the brazing metal filler is melted to fill a gap between the first pipe and the second pipe for joining, and the first pipe and the second pipe are contactless.

12. The dissimilar material pipe of claim 10, wherein the first pipe and the second pipe are made of dissimilar materials.

13. The dissimilar material pipe of claim 10, wherein the brazing metal filler has an alloy composition with a melting point of 450-550° C.

14. The dissimilar material pipe of claim 10, wherein the plastic deformation portion is plastically deformed by applying radial pressure.

15. The dissimilar material pipe of claim 10, wherein the first pipe is an aluminum (Al) pipe on a heat exchanger side in a liquid hydrogen system and the second pipe is a steel pipe on a hydrogen storage tank side in the liquid hydrogen system.
